(19) United States
(12) Patent Application Publication
(10) Pub. No.: US 2017/0130826 A1
(43) Pub. Date: May 11, 2017

(54) METHOD OF LEARNING AND CONTROLLING TRANSMISSION

(71) Applicant: Hyundai Motor Company, Seoul (KR)

(72) Inventor: Jun Sung PARK, Gunpo-si, Gyeonggi-do (KR)

(73) Assignee: Hyundai Motor Company, Seoul (KR)

(21) Appl. No.: 15/094,168

(22) Filed: Apr. 8, 2016

(30) Foreign Application Priority Data
Nov. 10, 2015 (KR) 10-2015-0157509

(51) Int. Cl. F16H 61/04

(52) U.S. Cl. CPC F16H 61/0437; F16H 2061/0462

(57) ABSTRACT

The present disclosure provides a method of learning and controlling a transmission that includes: a learning condition-checking step of checking whether there is a need for learning by comparing information about a vehicle collected from parts of the vehicle by a detector and transmitted to a controller with reference values kept in the controller; a slip amount-comparing step of comparing an actual slip amount of a damper clutch with a nominal slip amount inputted in advance in the controller, when the learning condition-checking step determines that there is a need for learning; and a learning step of performing learning as according to a learning value table inputted in advance in the controller on the basis of a result obtained by the controller in the slip amount-comparing step.

### CROSS REFERENCE TO RELATED APPLICATION

The present application claims priority to and the benefit of Korean Patent Application No. 10-2015-0157509, filed Nov. 10, 2015, which is incorporated by reference in its entirety.

### FIELD

The present disclosure relates to a method of correcting an automotive transmission defect.

### BACKGROUND

The statements in this section merely provide background information related to the present disclosure and may not constitute prior art.

In vehicles equipped with an automatic transmission, gears can be automatically changed to desired stages by controlling hydraulic pressure within predetermined shift ranges set on the basis of the speed of the vehicles and the open amount of a throttle valve.

Accordingly, in the vehicles equipped with an automatic transmission that is controlled in accordance with hydraulic pressure, there is no need for operating a clutch pedal for disconnecting power from the engine to shift to desired gears, so fatigue of a driver can be reduced and engine stall due to a mistake or unskilled driving of the driver while the vehicle is driven can be avoided, and thus, even beginners can easily drive a vehicle.

Such an automatic transmission changes torque from the engine, using a torque converter, and automatically shifts to desired gears by forming a hydraulic circuit such that desired friction elements can operate by controlling a solenoid valve in response to a control signal that is transmitted from a shift control unit in accordance with the driving states of a vehicle.

In the methods of correcting a hydraulic pressure difference in the related art, there is a method of using a learning function under actual driving conditions and reflecting a difference generated by a transmission to the learning function by comparing and estimating the current state with respect to desired performance in predetermined periods and performing control for correcting a corresponding hydraulic pressure level.

In particular, since transmissions are examined by examining samples randomly selected from complete products in the related art, that is, some of transmissions are representatively selected and examined, there is a large possibility of selecting products without defect, even though a defect rate is high in the actual fields.

Further, in the related art, there were transmissions that are sensitive to a deceleration direct-connection point and some that are not, but they are all controlled by the same control logic, so it is difficult to control the transmission in accordance with their characteristics, and when they were out of a control range, they are considered as poor products.

### SUMMARY

The present disclosure proposes a method of learning and controlling a transmission, whereby the method can perform customized control on manufactured transmissions on the basis of characteristics of the transmissions by learning the characteristics, may not need to manage hardware specifications by removing disconnection periods by linearly controlling the transmissions between control periods, and may improve productivity by removing a process of determining whether there is defect.

According to one aspect of the present disclosure, there is provided a method of learning and controlling a transmission that includes: a learning condition-checking step of checking whether there is a need for learning by comparing information about a vehicle collected from parts of the vehicle by a detector and transmitted to a controller with reference values kept in the controller; a slip amount-comparing step of comparing an actual slip amount of a damper clutch with a nominal slip amount inputted in advance in the controller, when the learning condition-checking step determines there is a need for the learning; and a learning step of performing the learning based on a learning value table inputted in advance in the controller on the basis of a result obtained by the controller in the slip amount-comparing step.

In the learning condition-checking step, whether the information about the vehicle collected from the parts of the vehicle satisfies a tip-in learning condition may be checked.

The method may further include a reaching time-comparing step of comparing a nominal reaching time of the damper clutch reaching a desired slip inputted in advance in the controller with an actual reaching time of the damper clutch actually reaching the desired slip in the learning condition-checking step.

When it is determined that the actual reaching time is larger than the nominal reaching time in the reaching time-comparing step, the slip amount-comparing step may be performed and it may be checked whether a maximum slip amount of the damper clutch is larger than the nominal slip amount of the damper clutch inputted in advance in the controller for the actual reaching time of the damper clutch reaching the desired slip amount.

When it is determined that the maximum slip amount is larger than the nominal slip amount in the slip amount-comparing step, a hydraulic pressure of the damper clutch may be determined as being lower than a reference level and a learning step of performing (+) learning on the basis of a learning value table inputted in advance in the controller may be performed. The expression “(+) learning” means the increase of the reference.

When it is determined that the maximum slip amount is smaller than the nominal slip amount in the slip amount-comparing step, a hydraulic pressure of the damper clutch may be determined as being higher than a reference level and a learning step of performing (−) learning on the basis of a learning value table inputted in advance in the controller may be performed. The expression “(−) learning” means the decrease of the reference.

When it is determined that the actual reaching time is smaller than the nominal reaching time in the reaching time-comparing step, a hydraulic pressure of the damper clutch may be determined as being higher than a reference level and a learning step of performing (−) learning on the basis of a learning value table inputted in advance in the controller may be performed.

Whether kick-down has been generated with an acceleration pedal pressed down may be checked in the learning condition-checking step.

The method may further include a shift end point-checking step of checking whether shift end points at a current value applied to the damper clutch and at a corresponding current value inputted in advance in the controller are the same in the learning condition-checking step.

When it is determined that the shift end points at the current value applied to the damper clutch and the corresponding current value inputted in advance in the controller are the same, the slip amount-comparing step may be performed.

When it is determined that the actual slip amount of the damper clutch is larger than the nominal slip amount inputted in advance in the controller in the slip amount-comparing step, a hydraulic pressure of the damper clutch may be determined as being lower than a reference level and a learning step of performing (+) learning on the basis of a learning value table inputted in advance in the controller may be performed.

When it is determined that the actual slip amount of the damper clutch is smaller than the nominal slip amount inputted in advance in the controller in the slip amount-comparing step, a hydraulic pressure of the damper clutch may be determined as being higher than a reference level and a learning step of performing (−) learning on the basis of a learning value table inputted in advance in the controller may be performed.

In the learning condition-checking step, it may be checked whether a transmission is in an in-gear tip-out stage and has entered a deceleration direct-connection state.

When it is determined that the learning condition is satisfied in the learning condition-checking step, a current duty value may be kept in the controller.

In the slip amount-comparing step, it may be checked whether an absolute value of an actual slip amount of the damper clutch satisfies a range of a desired slip amount inputted in advance in the controller over a reference time inputted in advance in the controller.

In the slip amount-comparing step, duty values for slip amounts may be compared.

In the slip amount-comparing step, when it is determined that the absolute value of the actual slip amount satisfies the range of the desired slip amount, the learning step may be performed and learning may be performed as according to a learning value table having an axis of a compensation duty value kept in the controller in the learning condition-checking step.

In the learning condition-checking step, whether lift-foot-up has been generated without the acceleration pedal pressed down may be checked.

The method may further include a shift end point-checking step of checking whether shift end points at a current value applied to the damper clutch and at a corresponding current value inputted in advance in the controller are the same in the learning condition-checking step.

When it is determined that the shift end points at the current value applied to the damper clutch and the corresponding current value inputted in advance in the controller are the same, the slip amount-comparing step may be performed.

When it is determined that the actual slip amount of the damper clutch is larger than the nominal slip amount inputted in advance in the controller in the slip amount-comparing step, a hydraulic pressure of the damper clutch may be determined as being lower than a reference level and a learning step of performing (+) learning on the basis of a learning value table inputted in advance in the controller may be performed.

When it is determined that the actual slip amount of the damper clutch is smaller than the nominal slip amount inputted in advance in the controller in the slip amount-comparing step, a hydraulic pressure of the damper clutch may be determined as being higher than a reference level and a learning step of performing (−) learning on the basis of a learning value table inputted in advance in the controller may be performed.

In the slip amount-comparing step, the nominal slip amount inputted in advance in the controller and the actual slip amount may be compared.

When it is determined that the actual slip amount is larger than the nominal slip amount in the slip amount-comparing step, a hydraulic pressure of the damper clutch may be determined as being lower than a reference level and a learning step of performing (+) learning on the basis of a learning value table inputted in advance in the controller may be performed.

When it is determined that the actual slip amount is smaller than the nominal slip amount in the slip amount-comparing step, a hydraulic pressure of the damper clutch may be determined as being higher than a reference level and a learning step of performing (−) learning on the basis of a learning value table inputted in advance in the controller may be performed.

According to the method of learning and controlling a transmission of the present disclosure, a current characteristic curve is linearly controlled by performing learning in accordance with characteristics of transmission after the transmission is manufactured, so control disconnection is removed and control can be performed along a curve. That is, unlike a learning method of the related art in which (+) or (−) off-set is generated and a nonlinear period is generated when periods are switched in which off-set is performed when periods such as deceleration direct-connection, low-torque tip-in, high-torque KD, and high-torque LFU are entered, linear control that applies a learned value to a hydraulic characteristic curve is applied. Accordingly, it is possible to perform customized control on a transmission on the basis of features of the transmission by learning the features, it may not be required to manage hardware specifications by removing disconnection periods by linearly controlling the transmission between control periods, and it is possible to improve productivity by removing a process of determining whether there is defect.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1 to 5 are flowcharts illustrating steps of a method of learning and controlling a transmission according to an embodiment of the present disclosure;

FIG. 6 is a block diagram illustrating a configuration for achieving the present disclosure; and

FIG. 7 is a PI diagram illustrating the concept of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A method of learning and controlling a transmission according to the present disclosure includes: a learning condition-checking step that checks whether there is a need for learning by comparing information about a vehicle collected from parts of the vehicle by a detector 100 and transmitted to a controller 300 with reference values kept in the controller 300 (S100); a slip amount-comparing step that compares the current (or actual) slip amount of a damper clutch 500 with a nominal slip amount kept in the controller 300 (S300), when the learning condition-checking step (S100) determines there is a need for learning; and a learning step that performs the learning as according to a learning value table inputted in advance in the controller 300 (S500) on the basis of the result obtained by the controller 300 in the slip amount-comparing step (S300).

Learning is controlled for each period on the basis of the learning condition-checking step (S100), slip amount-comparing step (S300), and learning step (S500). The present disclosure relates to a method of learning and controlling particularly the damper clutch 500 for inhibiting or preventing a power loss due to hydraulic pressure by directly connecting a fluid clutch in a torque converter of an automatic transmission 900 to a flywheel in the parts of the transmission 900.

Further, when an indirect connection state is changed to a direct connection state even in one transmission 900, a transient characteristic is shown, but when the direct connection state is changed to the indirect connection state, a steady characteristic is shown, so the learning and controlling are performed in consideration of these hydraulic pressure characteristics.

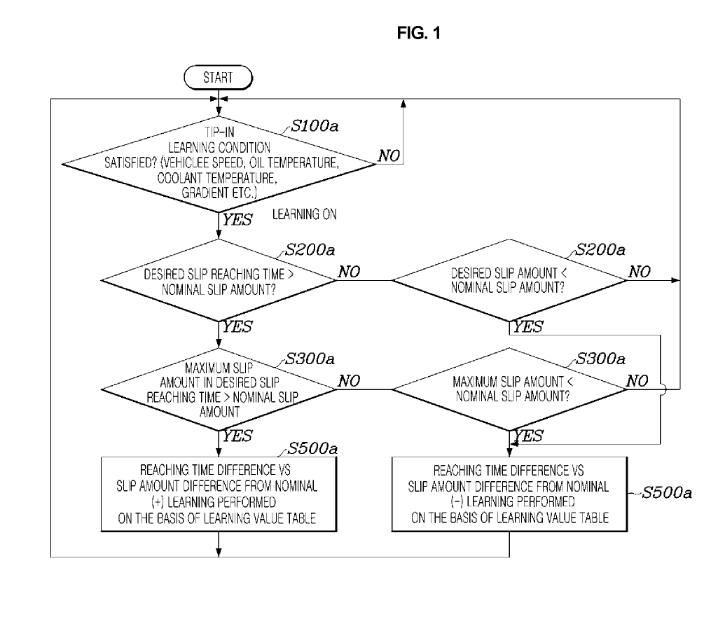

FIGS. 1 to 4 are block diagrams illustrating learning and controlling in periods having steady characteristics and the learning and controlling will be described first with respect to the figures.

FIG. 1 is a diagram illustrating a learning and controlling method in a tip-in period.

A learning condition-checking step that checks whether there is a need for learning by comparing information about a vehicle collected from parts of the vehicle by a detector 100 and transmitted to a controller 300 with reference values kept in the controller 300 (S100a) is performed. In the learning condition-checking step (S100a), whether information about a vehicle collected from parts of the vehicle satisfy a tip-in learning condition is checked, and the information transmitted to the controller 300 may be a vehicle speed, an oil temperature, a coolant temperature, and a gradient around a vehicle.

When the learning condition is determined as being satisfied in the learning condition-checking step (S100a), learning is started and a reaching time-comparing step that compares a nominal reaching time of the damper clutch 500 reaching a desired slip inputted in advance in the controller 300 with an actual reaching time of the damper clutch 500 actually reaching the desired slip (S200a) is further performed.

When it is determined that the actual reaching time is larger than the nominal reaching time in the reaching time-comparing step (S200a), a slip amount-comparing step (S300a) is performed. In the slip amount-comparing step (S300a), it is checked whether the maximum slip amount of the damper clutch 500 is larger than the nominal slip amount of the damper clutch 500 inputted in advance in the controller 300 for the actual reaching time of the damper clutch 500 reaching the desired slip amount.

When it is determined that the maximum slip amount is larger than the nominal slip amount in the slip amount-comparing step (S300a), the hydraulic pressure of the damper clutch 500 is determined as being lower than a reference level, so a learning step (S500a) that performs (+) learning on the basis of a learning value table inputted in advance in the controller 300 is performed and then the learning condition-checking step (S100a) is repeated.

However, when it is determined that the maximum slip amount is smaller than the nominal slip amount in the slip amount-comparing step (S300a), the hydraulic pressure of the damper clutch 500 is determined as being higher than the reference level, so a learning step (S500a) that performs (−) learning on the basis of a learning value table inputted in advance in the controller 300 is performed and then the learning condition-checking step (S100a) is repeated.

On the contrary, when it is determined that the actual reaching time is smaller than the nominal reaching time in the reaching time-comparing step (S200a), the hydraulic pressure of the damper clutch 500 is determined as being higher than the reference level, so the learning step (S500a) that performs (−) learning on the basis of a learning value table inputted in advance in the controller 300 is performed and then the learning condition-checking step (S100a) is repeated.

When it is determined that the maximum slip amount is the same as the nominal slip amount in the slip amount-comparing step (S300a), the learning condition-checking step (S100a) is repeated without performing the learning step (S500a). Similarly, when it is determined that the actual reaching time is the same as the nominal reaching time in the reaching time-comparing step (S200a), the learning condition-checking step (S100a) is repeated without performing the learning step (S500a).

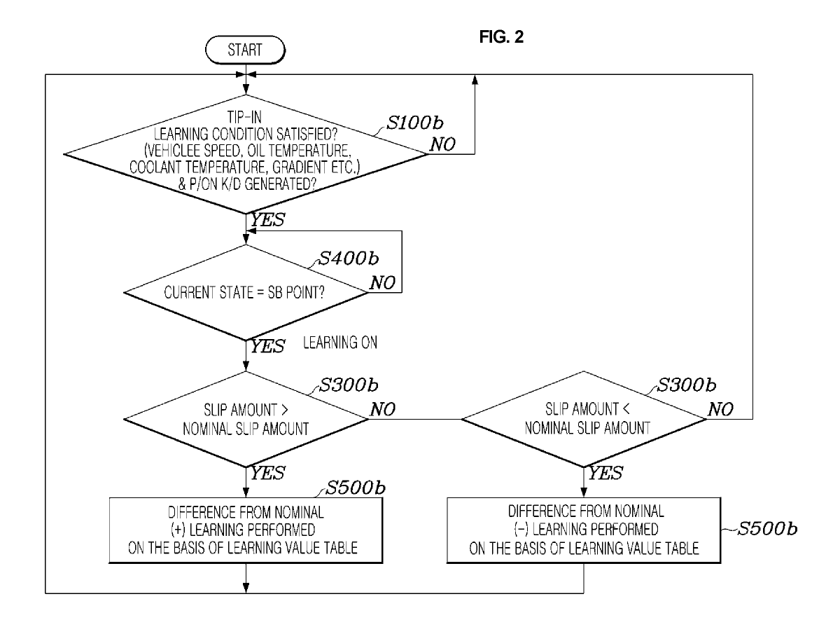

FIG. 2 is a diagram illustrating the learning and controlling method in a kick-down period with an acceleration pedal 700 pressed down.

A learning condition-checking step that checks whether there is a need for learning by comparing information about a vehicle collected from parts of the vehicle by the detector 100 and transmitted to the controller 300 with reference values kept in the controller 300 (S100b) is performed. In the learning condition-checking step (S100b), it is determined whether information about a vehicle collected from parts of the vehicle satisfies the tip-in learning condition and whether kick-down has been generated with the acceleration pedal 700 pressed down. The information transmitted to the controller 300 may be a vehicle speed, an oil temperature, a coolant temperature, and a gradient around a vehicle.

In the learning condition-checking step (S100b), a shift end point-checking step that checks whether shift end points at a current value applied to the damper clutch 500 and a corresponding current value inputted in advance in the controller 300 are the same (S400b) is further included. In the shift end point-checking step (S400b), a desired slip reaching time of the transmission 900 and the maximum slip amount at a shift end point that is the actual shift end point of time are determined and learning is performed. When it is determined that shift end points at a current value applied to the damper clutch 500 and a corresponding current value inputted in advance in the controller 300 are the same, learning is started and the slip amount-comparing step (S300b) is performed.

When it is determined that the actual slip amount of the damper clutch 500 is larger than the nominal slip amount inputted in advance in the controller 300 in the slip amount-comparing step (S300b), the hydraulic pressure of the damper clutch 500 is determined as being lower than a reference level, so a learning step (S500b) that performs (+) learning on the basis of the learning value table inputted in advance in the controller 300 is performed and then the learning condition-checking step (S100b) is repeated.

When it is determined that the actual slip amount of the damper clutch 500 is smaller than the nominal slip amount inputted in advance in the controller 300 in the slip amount-comparing step (S300b), the hydraulic pressure of the damper clutch 500 is determined as being higher than a reference level, so a learning step (S500b) that performs (−) learning on the basis of the learning value table inputted in advance in the controller 300 is performed and then the learning condition-checking step (S100b) is repeated.

On the other hand, when it is determined that the actual slip amount is the same as the nominal slip amount in the slip amount-comparing step (S300b), the learning condition-checking step (S100b) is repeated without performing the learning step (S500b), thereby controlling the transmission 900 on the basis of the learned contents.

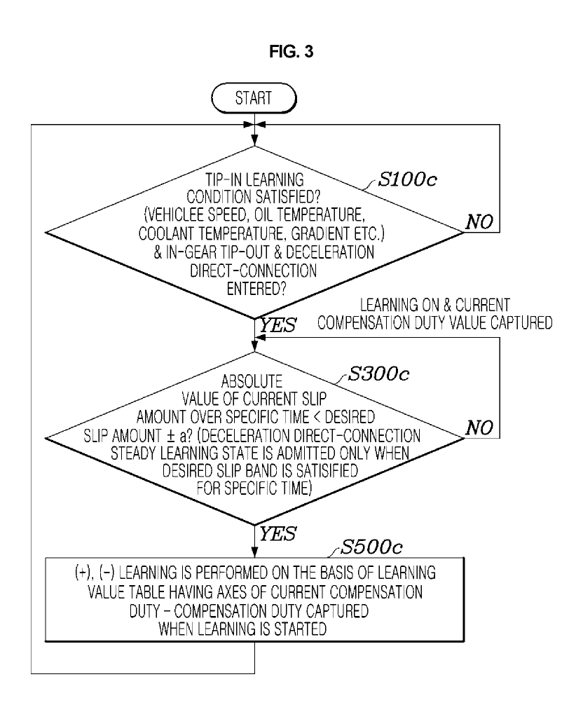

FIG. 3 is a diagram illustrating the learning and controlling method in a hysteresis period when a deceleration direct-connection stage has been entered, with the transmission 900 in an in-gear tip-out state.

A learning condition-checking step that checks whether there is a need for learning by comparing information about a vehicle collected from parts of the vehicle by the detector 100 and transmitted to the controller 300 with reference values kept in the controller 300 (S100c) is performed. In the learning condition-checking step (S100c), whether the information about the vehicle collected from the parts in the vehicle satisfies the tip-in learning condition is checked and whether the transmission 900 is in the in-gear tip-out state and it is a hysteresis period when the deceleration direct-connection stage has been entered is checked. The information transmitted to the controller 300 may be a vehicle speed, an oil temperature, a coolant temperature, and a gradient around a vehicle. Further, when the learning condition is determined as being satisfied in the learning condition-checking step (S100c), the controller 300 keeps a current compensation duty value.

In the slip amount-comparing step (S300c), it is checked whether the absolute value of the actual slip amount of the damper clutch 500 satisfies the range of a desired slip amount inputted in advance in the controller 300 over a reference time inputted in advance in the controller 300. That is, when the actual slip amount satisfies the range of the desired slip amount inputted in advance in the controller 300 for (or over) the reference time inputted in advance in the controller 300, the controller 300 determines it is a deceleration direct-connection steady learning state.

Accordingly, in the slip amount-comparing step (S300c), when it is determined that the absolute value of the actual slip amount satisfies the range of the desired slip amount, the learning step (S500c) is performed. In the learning step (S500c), learning is performed based on a learning value table having axes of the current compensation duty and the compensation duty kept in the controller 300 in the learning condition-checking step (S100c). In the slip amount-comparing step (S300c), duty values for slip amounts can be compared. In particular, in the tip-out deceleration direct-connection hysteresis period, PID controller can be performed by a PID (Proportional-Integral-Differential) controller, in which learning can be corrected by a PID correction gain. Further, the learning condition-checking step (S100c) is repeated after the learning step (S500c).

However, if it is determined that the absolute value of the actual slip amount does not satisfy the range of the desired slip amount in the slip amount-comparing step (S300c), the slip amount-comparing step (S300c) is repeated.

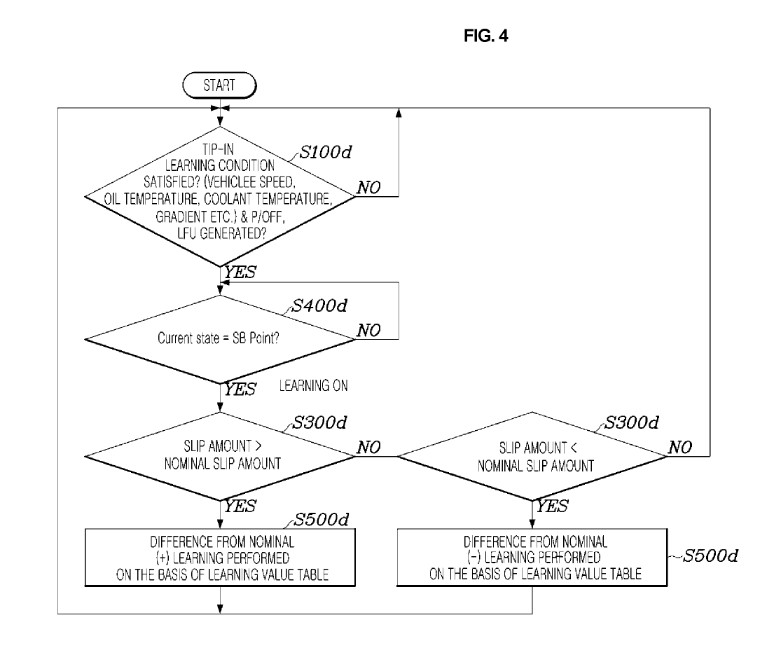

FIG. 4 is a diagram illustrating the learning and controlling method in a lift-foot-up period without the acceleration pedal pressed down.

A learning condition-checking step that checks whether there is a need for learning by comparing information about a vehicle collected from parts of the vehicle by the detector 100 and transmitted to the controller 300 with reference values kept in the controller 300 (S100d) is performed. In the learning condition-checking step (S100d), it is determined whether information about a vehicle collected from parts of the vehicle satisfy the tip-in learning condition and whether lift-foot-up has been generated without the acceleration pedal 700 pressed down. The information transmitted to the controller 300 may be a vehicle speed, an oil temperature, a coolant temperature, and a gradient around a vehicle.

In the learning condition-checking step (S100d), a shift end point-checking step that checks whether shift end points at a current value applied to the damper clutch 500 and a corresponding current value inputted in advance in the controller 300 are the same (400d) is further included. In the shift end point-checking step (S400d), a desired slip reaching time of the transmission 900 and the maximum slip amount at a shift end point that is the actual shift end point of time are determined and learning is performed. When it is determined that shift end points at a current value applied to the damper clutch 500 and a corresponding current value inputted in advance in the controller 300 are the same, learning is started and the slip amount-comparing step (S300d) is performed.

When it is determined that the actual slip amount of the damper clutch 500 is larger than the nominal slip amount inputted in advance in the controller 300 in the slip amount-comparing step (S300d), the hydraulic pressure of the damper clutch 500 is determined as being lower than a reference level, so a learning step (S500d) that performs (+) learning on the basis of the learning value table inputted in advance in the controller 300 is performed and then the learning condition-checking step (S100d) is repeated.

When it is determined that the actual slip amount of the damper clutch 500 is smaller than the nominal slip amount inputted in advance in the controller 300 in the slip amount-comparing step (S300d), the hydraulic pressure of the damper clutch 500 is determined as being higher than a reference level, so a learning step (S500d) that performs (−) learning on the basis of the learning value table inputted in advance in the controller 300 is performed and then the learning condition-checking step (S100d) is repeated.

On the other hand, when it is determined that the actual slip amount is the same as the nominal slip amount in the slip amount-comparing step (S300d), the learning condition-checking step (S100d) is repeated without performing the learning step (S500d), thereby controlling the transmission 900 on the basis of the learned contents.

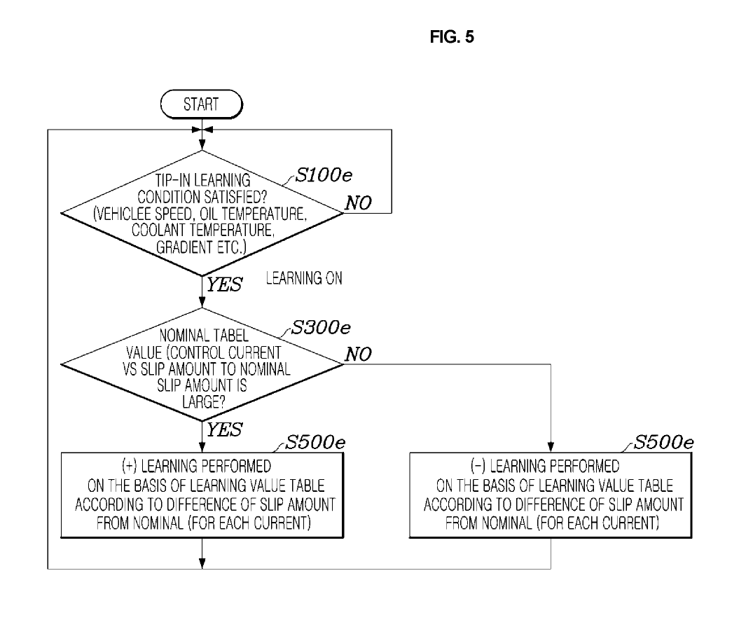

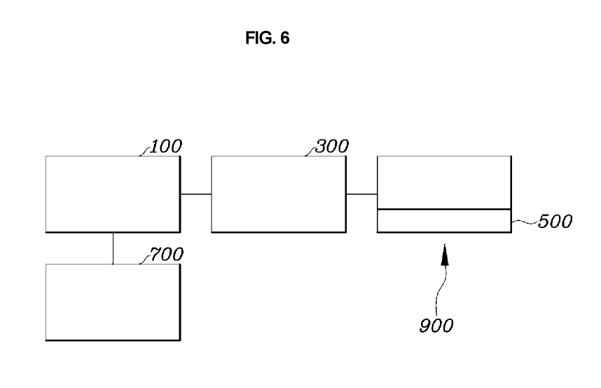

Next, FIG. 5 is a block diagram illustrating the learning and controlling method in a period having a transient characteristic, in which a hydraulic pressure delay is shown when a non-direct connection state is changed to a direct connection state.

A learning condition-checking step that checks whether there is a need for learning by comparing information about a vehicle collected from parts of the vehicle by the detector 100 and transmitted to the controller 300 with reference values kept in the controller 300 (S100e) is performed. In the learning condition-checking step (S100e), whether information about a vehicle collected from parts of the vehicle and transmitted to the controller 300 may be a vehicle speed, an oil temperature, a coolant temperature, and a gradient around a vehicle.

When it is determined that the learning condition is satisfied and there is a need for learning in the learning condition-checking step (S100e), learning is started and the slip amount-comparing step (S300e) that compares the nominal slip amount inputted in advance in the controller 300 with the actual slip amount is performed.

When it is determined that the maximum slip amount is larger than the nominal slip amount in the slip amount-comparing step (S300e), the hydraulic pressure of the damper clutch 500 is determined as being lower than a reference level, so a learning step (S500e) that performs (+) learning according to a slip amount difference from the nominal slip amount on the basis of a learning value table inputted in advance in the controller 300 is performed and then the learning condition-checking step (S100e) is repeated.

On the contrary, when it is determined that the maximum slip amount is smaller than the nominal slip amount in the slip amount-comparing step (S300e), the hydraulic pressure of the damper clutch 500 is determined as being higher than a reference level, so a learning step (S500e) that performs (−) learning according to a slip amount difference from the nominal slip amount on the basis of a learning value table inputted in advance in the controller 300 is performed and then the learning condition-checking step (S100e) is repeated.

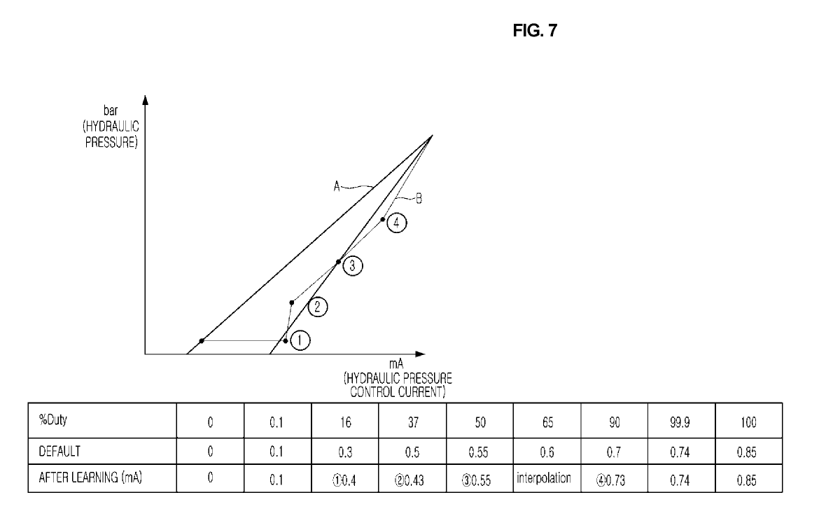

As described above, the method of learning and controlling a transmission of the present disclosure checks whether there is reaction by applying a current corresponding to a deceleration direct-connection point when engaging and disengaging a torque converter on the basis of a map (a learning value table) inputted in advance in the controller 300, and performs learning from the reaction point. That is, a learning value table inputted when the transmission 900 is manufactured and a corresponding nominal slip amount are selected as references and it is checked that how much the actual slip amount comes out of the reference point by the controller 300. Thereafter, it is determined whether the part out of the reference point needs (+) learning due to low hydraulic pressure or (−) learning due to excessive hydraulic pressure and then control is performed on the basis of the learned contents as a new reference. The above description is shown in FIG. 7. In FIG. 7, the line A indicates a nominal slip amount and the line B indicates learning according to an actual slip amount. In this case, a learning value table may be constructed by a current and a slip amount (pressure). Further, control may be performed on the basis of a duty value.

FIG. 7 is a PI graph showing current according to pressure, in which it was found that, as for point 1, the current according to the pressure at point 1 on the reference graph is 0.3 mA, but the current measured for the actual slip amount is 0.4 mA. Accordingly, the controller 300 increases the reference value, which was previously input, from 0.3 mA from 0.4 mA. As for point 2 on the reference graph, it is found that the current according to pressure is 0.5 mA, but the current measured for the actual slip amount is 0.43 mA. Accordingly, the controller 300 decreases the reference from 0.5 mA, which was previously input, to 0.43 mA. As for point 3, the current according to pressure on the reference graph and the current measured for the actual slip amount is the same, 0.55 mA, so the controller 300 does not perform learning. Further, as for point 4, the current according to pressure on the reference graph is 0.7 mA, but the current for the actual slip amount is 0.73 mA, so the controller 300 increases the reference similar to point 1. As described above, increasing the reference is defined as (+) learning and decreasing the reference is defined as (−) learning.

In particular, a PI graph shows a linear characteristic in a steady characteristic state, but a hydraulic pressure delay is shown in a transient characteristic state. Accordingly, learning is separately performed for direct connection control in which hydraulic pressure for PI curve learning is ensured at a predetermined level and for change from non-direct connection to direct connection in which hydraulic pressure is supplemented, and found values are kept in ramcells of cells of different controllers and separately applied for later behaviors.

According to the method of learning and controlling a transmission according to an embodiment of the present disclosure, a current characteristic curve is linearly controlled by performing learning in accordance with characteristics of transmission after the transmission are manufactured, so control disconnection is removed and control can be performed along a curve. That is, unlike a learning method of the related art in which (+) or (−) off-set is generated and a nonlinear period is generated when periods are switched in which off-set is performed when periods such as deceleration direct-connection, low-torque tip-in, high-torque KD, and high-torque LFU are entered, linear control that applies a learned value to a hydraulic characteristic curve is applied. Accordingly, it is possible to perform customized control on a transmission on the basis of features of the transmission by learning the features, it may be not required to manage hardware specifications by removing disconnection periods by linearly controlling the transmission between control periods, and it is possible to improve productivity by removing a process of determining whether there is defect.

Although the present disclosure was described with reference to specific embodiments shown in the drawings, it is apparent to those skilled in the art that the present disclosure may be changed and modified in various ways without departing from the scope of the present disclosure.

What is claimed is:

1. A method of learning and controlling a transmission, the method comprising:
a learning condition-checking step of checking whether there is a need for learning by comparing information about a vehicle collected from parts of the vehicle by a detector and transmitted to a controller with reference values kept in the controller;
a slip amount-comparing step of comparing an actual slip amount of a damper clutch with a nominal slip amount inputted in advance in the controller, when the learning condition-checking step determines there is the need for the learning; and
a learning step of performing the learning based on a learning value table inputted in advance in the controller on the basis of a result obtained by the controller in the slip amount-comparing step.

2. The method of claim 1, wherein in the learning condition-checking step, whether the information about the vehicle collected from the parts of the vehicle satisfies a tip-in learning condition is checked.

3. The method of claim 2, further comprising a reaching time-comparing step of comparing a nominal reaching time of the damper clutch reaching a desired slip inputted in advance in the controller with an actual reaching time of the damper clutch actually reaching the desired slip in the learning condition-checking step.

4. The method of claim 3, wherein when the actual reaching time is larger than the nominal reaching time in the reaching time-comparing step, the slip amount-comparing step is performed, and checking whether a maximum slip amount of the damper clutch is larger than the nominal slip amount of the damper clutch inputted in advance in the controller for the actual reaching time of the damper clutch reaching the desired slip amount.

5. The method of claim 4, wherein when the maximum slip amount is larger than the nominal slip amount in the slip amount-comparing step, a hydraulic pressure of the damper clutch is determined as being lower than a reference level and a learning step of performing (+) learning on the basis of a learning value table inputted in advance in the controller is performed; and
wherein when the maximum slip amount is smaller than the nominal slip amount in the slip amount-comparing step, a hydraulic pressure of the damper clutch is determined as being higher than a reference level and a learning step of performing (−) learning on the basis of a learning value table inputted in advance in the controller is performed.

6. The method of claim 3, wherein when the actual reaching time is smaller than the nominal reaching time in the reaching time-comparing step, a hydraulic pressure of the damper clutch is determined as being higher than a reference level and a learning step of performing (−) learning on the basis of a learning value table inputted in advance in the controller is performed.

7. The method of claim 2, wherein whether kick-down has been generated with an acceleration pedal pressed down is checked in the learning condition-checking step.

8. The method of claim 7, further comprising a shift end point-checking step of checking whether shift end points at a current value applied to the damper clutch and at a corresponding current value inputted in advance in the controller are the same in the learning condition-checking step.

9. The method of claim 8, wherein when the shift end points at the current value applied to the damper clutch and the corresponding current value inputted in the controller are the same, the slip amount-comparing step is performed.

10. The method of claim 9, wherein when the actual slip amount of the damper clutch is larger than the nominal slip amount inputted in the controller in the slip amount-comparing step, a hydraulic pressure of the damper clutch is determined as being lower than a reference level and a learning step of performing (+) learning on the basis of a learning value table inputted in advance in the controller is performed; and
wherein when the actual slip amount of the damper clutch is smaller than the nominal slip amount inputted in the controller in the slip amount-comparing step, the hydraulic pressure of the damper clutch is determined as being higher than the reference level and a learning step of performing (−) learning on the basis of the learning value table inputted in the controller is performed.

11. The method of claim 2, further comprising: in the learning condition-checking step, checking whether a transmission is in an in-gear tip-out stage and whether the transmission has entered a deceleration direct-connection state.

12. The method of claim 11, wherein when learning conditions are satisfied in the learning condition-checking step, a current duty value is kept in the controller.

13. The method of claim 12, further comprising: in the slip amount-comparing step, checking whether an absolute value of the actual slip amount of the damper clutch satisfies a range of a desired slip amount inputted in advance in the controller over a reference time inputted in advance in the controller.

14. The method of claim 13, wherein in the slip amount-comparing step, duty values for slip amounts are compared.

15. The method of claim 12, wherein in the slip amount-comparing step, when an absolute value of the actual slip amount of the damper clutch satisfies a range of a desired slip amount inputted in advance in the controller, the learning step is performed and learning is performed as according to a learning value table having an axis of a compensation duty value kept in the controller in the learning condition-checking step.

16. The method of claim 2, wherein in the learning condition-checking step, whether lift-foot-up has been generated without an acceleration pedal pressed down is checked.

17. The method of claim 16, further comprising a shift end point-checking step of checking whether shift end points at a current value applied to the damper clutch and at a corresponding current value inputted in advance in the controller are the same in the learning condition-checking step; and
wherein when the shift end points at the current value applied to the damper clutch and the corresponding current value inputted in the controller are the same, the slip amount-comparing step is performed.

18. The method of claim 17, wherein when the actual slip amount of the damper clutch is larger than the nominal slip amount inputted in the controller in the slip amount-comparing step, a hydraulic pressure of the damper clutch is determined as being lower than a reference level and a learning step of performing (+) learning on the basis of a learning value table inputted in advance in the controller is performed; and
wherein when the actual slip amount of the damper clutch is smaller than the nominal slip amount inputted in the controller in the slip amount-comparing step, the hydraulic pressure of the damper clutch is determined as being higher than the reference level and a learning step of performing (−) learning on the basis of the learning value table inputted in the controller is performed.

19. The method of claim 1, wherein in the slip amount-comparing step, the nominal slip amount inputted in the controller and the actual slip amount are compared.

20. The method of claim 19, wherein when the actual slip amount is larger than the nominal slip amount in the slip amount-comparing step, a hydraulic pressure of the damper clutch is determined as being lower than a reference level and a learning step of performing (+) learning on the basis of a learning value table inputted in advance in the controller is performed; and
wherein when the actual slip amount is smaller than the nominal slip amount in the slip amount-comparing step, a hydraulic pressure of the damper clutch is determined as being higher than a reference level and a learning step of performing (−) learning on the basis of a learning value table inputted in advance in the controller is performed.
